(19) United States
(12) Patent Application Publication
(10) Pub. No.: US 2009/0211531 A1
(43) Pub. Date: Aug. 27, 2009

(54) SANDBOX APPARATUS

(76) Inventor: Shu-Huei LAI, Taichung City (TW)

Correspondence Address: Dr. BANGER SHIA, 102 Lindencrest Ct., Sugar Land, TX, 77479-5201, US

(21) Appl. No.: 12/036,504

(22) Filed: Feb. 25, 2008

(51) Int. Cl. A01K 29/00

(52) U.S. Cl. 119/165

(57) ABSTRACT

A sandbox apparatus includes a sandbox, a covering device and a lid-controlling device. The covering device includes an annular body mounted on the sandbox and a lid pivotally connected to the annular body. On sensing a cat, the lid-controlling device raises the lid from the annular body. After the cat leaves the sandbox, the lid-controlling device lowers the lid onto the annular body.

### BACKGROUND OF INVENTION

1. Field of Invention

The present application relates to a sandbox and, more particularly, to an automatic sandbox apparatus.

2. Related Prior Art

Many people keep cats as pets. Most of these cats eventually learn to use sandboxes after taking training programs. Owners clean the sandboxes from time to time.

The sandboxes are generally open boxes. The cats lay their urine and excrement in the sandboxes. The urine and excrement of the cats smell. If the owners do not clean the sandboxes frequently, their dwellings will be filled with bad smell.

To keep their dwellings from the bad smell, the owners may cover the sandboxes with covers. However, the cats will experience troubles trying to remove the covers from the sandboxes and eventually give up using the sandboxes and lay their urine and excrement everywhere in the ownersødwellings. Even if some of the cats learn to remove the covers, they cannot put the covers back on the sandboxes, and the owners' dwellings will be filled with the bad smell.

The present invention is therefore intended to obviate or at least alleviate the problems encountered in prior art.

### SUMMARY OF INVENTION

The primary objective of the present invention is to provide an automatic sandbox apparatus.

To achieve the primary objective of the present invention, a sandbox apparatus includes a sandbox, a covering device and a lid-controlling device. The covering device includes an annular body mounted on the sandbox and a lid pivotally connected to the annular body. On sensing a cat, the lid-controlling device raises the lid from the annular body. After the cat leaves the sandbox, the lid-controlling device lowers the lid onto the annular body.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is an exploded view of a sandbox apparatus according to the preferred embodiment of the present invention.

FIG. 2 is a perspective view of the sandbox apparatus shown in FIG. 1.

FIG. 3 is a perspective view of the sandbox apparatus in an open position instead of a closed position shown in FIG. 2.

FIG. 4 is a perspective view of a cat approaching the sandbox apparatus shown in FIG. 2.

FIG. 5 is a perspective view of the sandbox apparatus opening itself after sensing the cat shown in FIG. 4.

FIG. 6 is a perspective view of the cat using the sandbox apparatus shown in FIG. 5.

FIG. 7 is another exploded view of the sandbox apparatus shown in FIG. 1.

### DETAILED DESCRIPTION OF PREFERRED EMBODIMENT

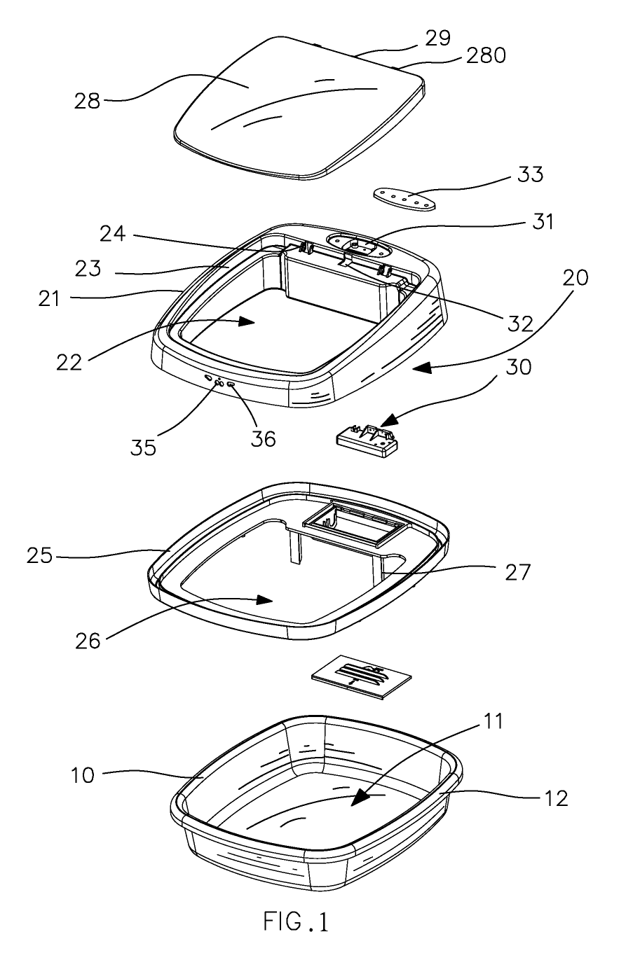

Referring to FIG. 1, a sandbox apparatus includes a sandbox 10, a covering device 20 and a lid-controlling device.

The sandbox 10 includes a space 11 centrally defined therein and a retroflex annular edge 12 around the space 11. The retroflex annular edge 12 facilitates the carrying of the sandbox 10.

The covering device 20 includes a lid 28 and an annular body. The annular body includes an upper shell 21 and a lower shell 25. The lower shell 25 includes an opening 26 defined therein and two legs 27 extended from the bottom. The lower shell 25 can be located on the sandbox 10, with the legs 27 inserted in the sandbox 10, thus positioning the lower shell 25 on the sandbox 10.

The upper shell 21 includes an opening 22 defined therein, a stepped annular edge 23 around the opening 22 and two pairs of ears 24 thereon. The upper shell 21 is attached to the lower shell 25.

The lid 28 includes two ears 280 thereon and a gear 29 thereon. Each of the ears 280 is connected to a related one of the pairs of ears 24 so that the lid 28 is pivotally connected to the sandbox 10.

The lid 28 is guided by the stepped annular edge 23 when the lid 28 is lowered near the upper shell 21. The lid 28 is restrained by the stepped annular edge 23 when the lid 28 is located on the upper shell 21.

The lid-controlling device includes a circuit board 30, a motor 31, a gear 32, a panel 33, sensors 35 and buttons 36. The circuit board 30 is disposed in the upper shell 21. The motor 31 is also disposed in the upper shell 21. The motor 31 is connected to the circuit board 30 so that the activating and stopping of the motor 31 is under the control of the circuit board 30. The gear 32 is operatively connected to the motor 31 and engaged with the gear 29. When activated by the circuit board 30, the motor 31 drives the gear 32 that rotates the gear 29 and therefore pivots the lid 28.

The panel 33 is connected to the circuit board 30. By operating the panel 33, the lid-controlling device is operated and set. The sensors 35 are connected to the circuit board 30. On sensing a cat, each of the sensors 35 sends a signal to the circuit board 30. On receiving the signal, the circuit board 30 activates the motor 31.

The buttons 36 are connected to the circuit board 30. When pushed, each of the buttons 36 sends a signal to the circuit board 30. On receiving the signal, the circuit board 30 activates the motor 31. One of the buttons 36 can be used to raise the lid 28 while the other button 36 can be used to lower the lid 28. Alternatively, both of the buttons 36 can be used to raise and lower the lid 28.

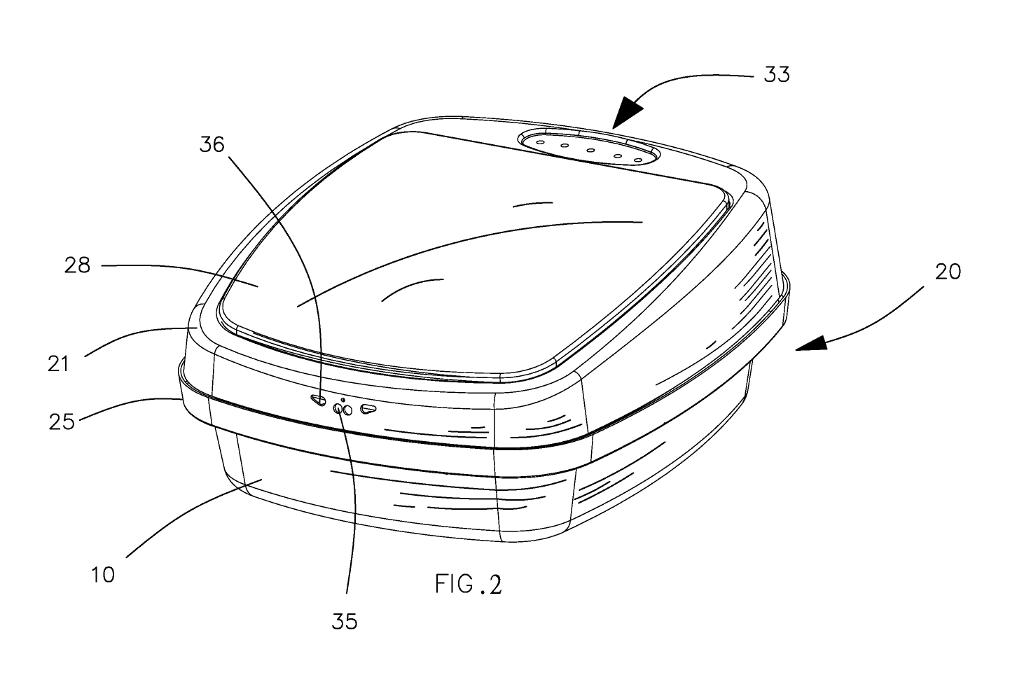

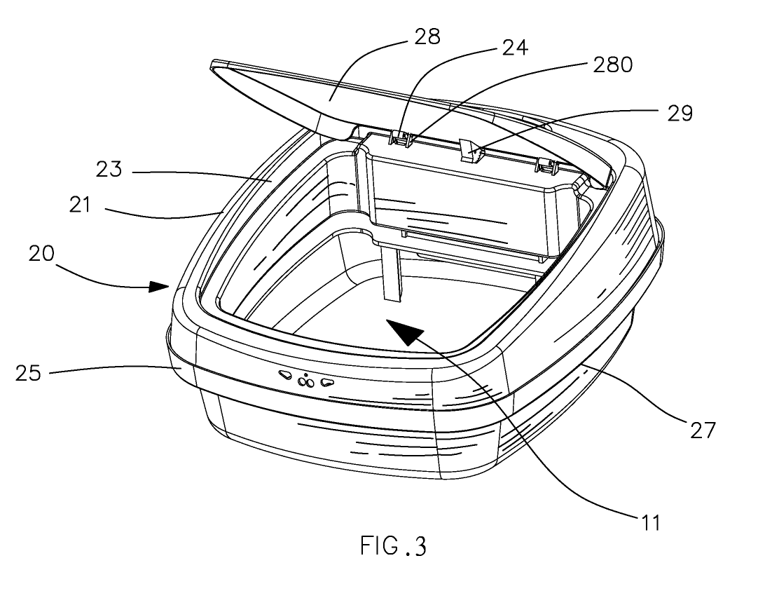

Referring to FIGS. 2 and 3, the sandbox apparatus can automatically open and close itself.

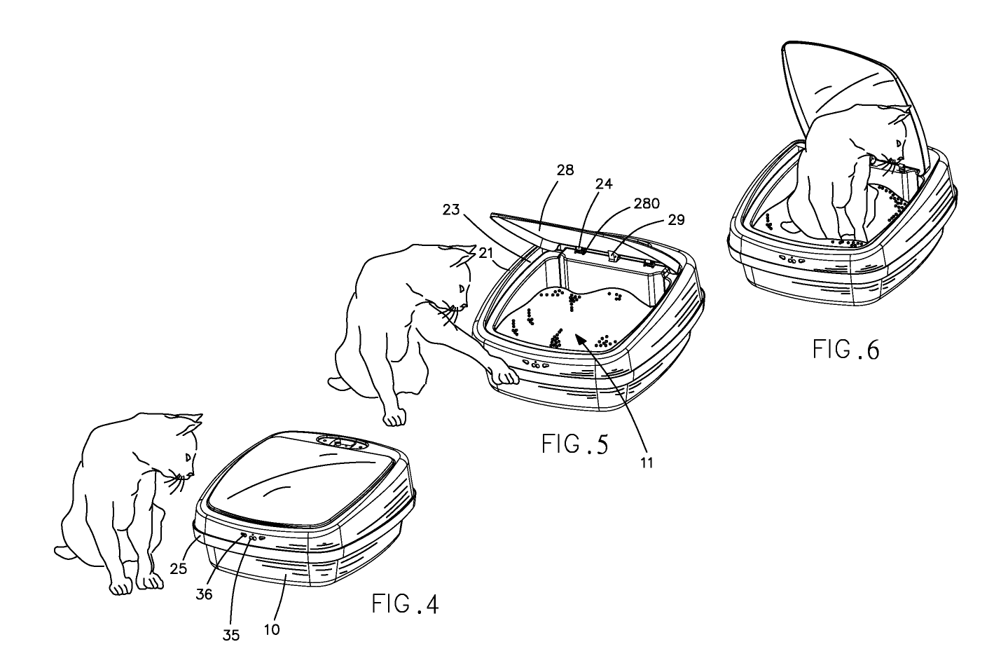

Referring to FIG. 4, a cat approaches the sandbox apparatus.

Referring to FIG. 5, at least one of the sensors 35 senses the cat and sends a signal to the circuit board 30. On receiving the signal, the circuit board 30 activates the motor 31. The motor 31 drives the gear 32 that in turn rotates the gear 29 and therefore raises the lid 28.

Referring to FIG. 6, the lid 28 is fully raised so that the cat can use the sandbox apparatus.

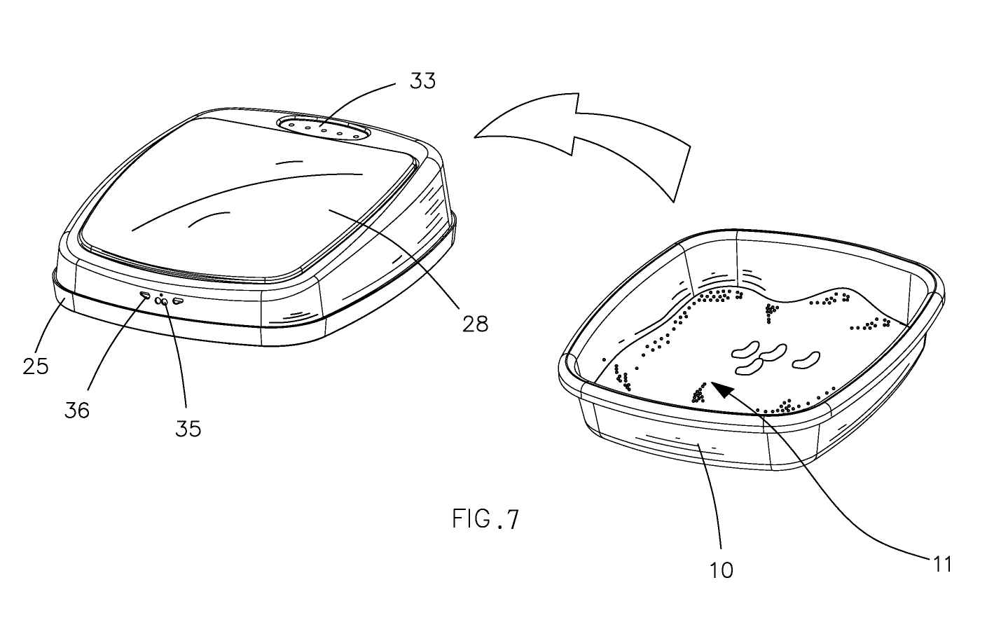

Referring to FIG. 7, the covering device is removed from the sandbox 10 so that the sandbox 10 can be cleaned.

The sandbox apparatus opens itself on sensing the cat so that the cat can use the sandbox apparatus. After the cat leaves, the sandbox closes itself to shut the smell of the urine and excrement inside.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A sandbox apparatus comprising:
a sandbox;
a covering device comprising an annular body mounted on the sandbox and a lid pivotally connected to the annular body; and
a lid-controlling device for raising the lid from the annular body on sensing a cat and lowering the lid onto the annular body after the cat leaves the sandbox.

2. The sandbox apparatus according to claim 1, wherein the lid comprises a gear thereon, and the lid-controlling device comprises a gear engaged with the gear of the lid.

3. The sandbox apparatus according to claim 2, wherein the lid-controlling device comprises a motor for driving the gear thereof.

4. The sandbox apparatus according to claim 3, wherein the lid-controlling device comprises a circuit board for controlling the activation and stopping of the motor.

5. The sandbox apparatus according to claim 4, wherein the lid-controlling device comprises at least one sensor connected to the circuit board so that on sensing the pet, the sensor sends a signal to the circuit board that in turn activates the motor.

6. The sandbox apparatus according to claim 4, wherein the lid-controlling device comprises a panel located on the annular body and connected to the circuit board so that the lid-controlling device can be operated and set by operating the panel.

7. The sandbox apparatus according to claim 4, wherein the lid-controlling device comprises at least one button located on the annular body and connected to the circuit board so that when pushed, the button sends a signal to the circuit board that in turn activates the motor.

8. The sandbox apparatus according to claim 1, wherein the sandbox comprises a retroflex annular edge for facilitating the carrying thereof.

9. The sandbox apparatus according to claim 1, wherein the annular body comprises a stepped annular edge for guiding the lid.

10. The sandbox apparatus according to claim 1, wherein the annular body comprises at least one ear, and the lid comprises at least one ear connected to the ear.

11. The sandbox apparatus according to claim 1, wherein the annular body comprises an upper shell for supporting the lid and a lower shell attached to the upper shell and rested on the sandbox.
